(19) United States
(12) Patent Application Publication
(10) Pub. No.: US 2004/0227751 A1
(43) Pub. Date: Nov. 18, 2004

(54) Method for capturing object images for 3D representation

(75) Inventor: James K. Anders, Southampton, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Kaidan Incorporated

(21) Appl. No.: 10/753,627

(22) Filed: Jan. 8, 2004

Related U.S. Application Data
(60) Provisional application No. 60/438,744, filed on Jan. 8, 2003.

(51) Int. Cl. G06T 15/00

(52) U.S. Cl. 345/419

(57) ABSTRACT

A method of generating a three-dimensional image of an object includes placing a video camera at a predetermined distance from the object, such that the video camera has an unobstructed view of the object, and causing the object to rotate about a central axis. A video stream of at least one revolution of the rotating object is captured with the video camera. A period of the at least one revolution of the object is determined. A predetermined number of frames of the captured video stream are selected, and a three-dimensional image of the object using the selected frames is created.

### CROSS-REFERENCE TO RELATED APPLICATIONS

This application claims the benefit of U.S. Provisional Patent Application No. 60/438,744 filed Jan. 8, 2003, and entitled “Method For Capturing Object Images For 3D Representation.”

### BACKGROUND OF THE INVENTION

The present invention relates generally to a method and apparatus for generating a three dimensional (“3D”) representation of an object. More specifically, the present invention focuses on capturing and producing a 3D representation of an object for display and visualization on a computer screen. Such a representation may be desired to be viewed from an independent computer file, an image from or within a computer program, or as an image viewable or downloadable over the internet. The goal is that no matter which of the above methods are employed, the user is able to view a full and accurate 3D representation and/or animation of the object on a screen instead of a flat two dimensional depiction of the object as provided in a conventional approach. To achieve the 3D effect, a method of capturing and storing a 3D representation of an object in computer memory is required.

The present technology for displaying and viewing 3D objects on a computer, such as Apple's QuickTime VR, uses well known methods of displaying the object. With these conventional methods, photographs of the object or subject to be displayed are taken at regular intervals. The resulting images are then displayed in an indexed sequence which can be controlled independently by the viewing user or automatically by the displaying software or internet browser. The user wishing to view an object may, for example, have the ability to control the image by moving the mouse left or right or up or down, thereby controlling the playback or display of the sequential indexed images so that the user is able to view all sides and all portions of the displayed object as desired. Thus, the user sees the object as if it is moving in 3D space. Similarly, the user might instruct the playback software to automatically display the 3D image in rotating animated form. Here, the software controls the display of the indexed sequence so, for example, the object makes one complete revolution for the viewer.

In order for the software or image viewer to display the desired object, the object must first be photographed and captured by computer software so that the viewer has a sequence of images to display. For example, suppose a statue is the desired object for display. A photograph could be taken of the statue at every 10° interval. Therefore, there would be 36 images (360°/10°) available to be sequenced to simulate rotation of the statue. In order to simulate an accurate 3D representation, each photograph of the statue must be taken at the next subsequent 10° interval, not merely at any 10° interval about the statue. Furthermore, these 36 images must then be sequenced in the order they were taken (i.e., at each increasing 10° interval). To display a finer resolution of the statue, photographs should be taken at more frequent intervals (i.e., every 5° or every 1°), thereby producing a greater number of images to be sequenced and displayed. The conventional method of accomplishing this is either through manual or automatic rotation of the statue, so photographs may be taken at each designated point. For example, the statue could be placed on a revolving tray or turntable, such as a lazy Susan, which is manually rotated to the next desired position for the next photograph to be taken. This manual method of capturing object images may be inaccurate because the user must determine when and where to stop the turntable for the next photograph to be taken. It is also time consuming and cumbersome. Alternatively, the statue could be placed on an automatic turntable, to be started and stopped at regular intervals. Here, the positions at which the turntable stops are more accurate because it is automatically controlled. However, this method is also cumbersome because of the need for a turntable controller. It is also very expensive. In both the manual and automatic methods, photographs of the statue must be taken at each interval after the turntable has come to a stop.

One solution to the problems discussed above is to use a video camera to continually capture the image of the object as it rotates. A challenge for this technique is to accurately time the process of the rotation to provide an accurate and complete revolution of the turntable. This is important because the start and stop (beginning and end) points of a single complete revolution must be known in order to divide the single complete revolution into a desired number of incrementally spaced images. Thus, the time for a complete revolution (i.e., the period, T, of the turntable), together with the precise rotational speed of the turntable, is used to determine how frequently a single image of the captured video stream is isolated for use in the 3D representation of the object.

For example, suppose that the automatic turntable spins at an exact constant speed of 5 revolutions per minute (“RPM”). This means that the period T of the turntable is 12 seconds. Further suppose that the 3D representation of the object calls for an image resolution of an image at every 30° interval. This means that a single image must be culled out of the captured video stream every 30° of rotation. Thus, at 30 frames a second for 12 seconds there are 360 frames or images in the captured stream. Since one complete revolution comprises 360°, a resolution of every 30° of rotation means that only 12 images will be selected out of the entire video stream (360 divided by 30). Therefore, with 360 frames over the entire 12 seconds of video data, every 30^{th} image in the series is selected for use in the 3D representation of the object. This method, however, requires knowledge of the exact speed of the turntable. Additionally, the exact speed of the turntable must remain constant and be controlled to ensure constant speed. Therefore, either a special speed control feedback mechanism or timing circuit must be used to provide a constant known rotational speed. This timing and/or control aspect adds cost and equipment to the automatic rotating turntable system.

In sum, there is an unmet need for a simple and inexpensive process to create a 3D object representation. The present invention fulfills this need by using the video data stream itself to determine what sequence of image frames comprise a full rotation of the object.

### BRIEF SUMMARY OF THE INVENTION

Briefly stated, according to the present invention, a method of generating a three-dimensional image of an object includes placing a video camera at a predetermined distance from the object, such that the video camera has an unobstructed view of the object, and causing the object to rotate about a central axis. A video stream of at least one revolution of the rotating object with the video camera is captured. The period of the at least one revolution of the object is determined. A predetermined number of frames of the captured video stream are selected, and a three-dimensional image of the object is created using the selected frames.

### BRIEF DESCRIPTION OF THE SEVERAL VIEWS OF THE DRAWINGS

The following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

The patent or application file contains at least one drawing executed in color. Copies of this patent or patent application publication with color drawing(s) will be provided by the Office upon request and payment of the necessary fee.

In the drawings:

FIG. 1 is a block diagram of a first preferred embodiment of an image capturing system in accordance with the present invention;

FIG. 2 is an example time-line and corresponding frame table in accordance with the present invention;

FIG. 3 is a sample table showing frame numbers and corresponding degrees of rotation according to the present invention;

FIG. 4 is a series of images representing sample image captures in accordance with the present invention;

FIG. 5 is a graph showing an example of color coded video difference values generated by one type of pixel matching software used with the present invention; and

FIG. 6 is a pair of graphs comparing examples of video difference data, where the rotational speeds of the objects are different.

### DETAILED DESCRIPTION OF THE INVENTION

The present inventive method may be used in numerous situations and implementations, some of which are described below.

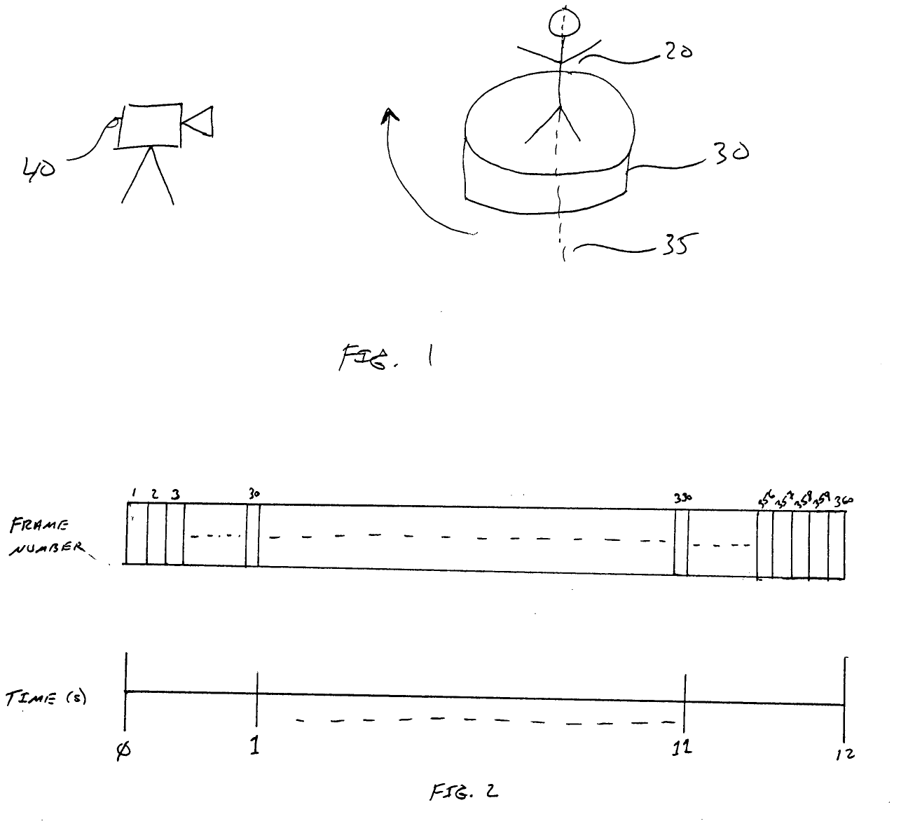

FIG. 1 shows a 3D object capturing system 10. The system 10 includes an object 20 positioned on a turntable 30. The turntable 30 rotates about a central axis 35. The turntable 30 may be freely rotateable about the axis 35, capable of rotation in either direction about the axis 35 at a constant or variable speed. The turntable 30 may also be a controlled turntable, that is, one which is controlled by any number of means and/or mechanisms to specify the direction and speed of rotation. The system 10 further includes a video camera 40 positioned at some distance away from the turntable 30 so that the camera 40 has a clear, unobstructed view of the object 20 as the turntable 30 rotates. The object 20 is preferably positioned on the turntable 30 so that it is positioned in the center of the turntable 30 with the central axis 35 passing through both the center of the turntable 30 and the center of the object 20. The system 10 is designed such that the video camera 40 captures a continuous video data stream of the object 20 as it rotates with the turntable 30 for eventual display and/or animation on a computer screen as a representative 3D image of the object 20. Unlike conventional methods, the system 10 accomplishes this video capture and subsequent 3D image display without independent knowledge of the speed or direction of rotation of the turntable 30.

To depict an accurate 3D representation of the object 20, it is preferable to use a number of captured images of the object 20 at evenly spaced angular intervals around the object 20. The finer the desired resolution of the 3D image, the greater the number of evenly angularly displaced captured images are used and hence, the smaller the angular interval between images. Thus, for a given frame rate of the video camera 40 a total number of individual frames of the rotating object 20 exist. The desired resolution chosen by the user therefore determines the number of evenly angularly displaced images which are used to form the 3D representation of the object 20. However, it is the period T, or the speed of the turntable 30 which determines the total number of frames available. Thus, the total number of frames equals the frame rate (in number of frames per second) multiplied by the period T (in seconds). Once the total number of frames is determined, it is a simple mathematical calculation to determine the number of evenly spaced frames used to form the 3D representation. It should be noted that the 3D representation afforded by the present invention is not a true 3D image in the sense that thee dimensional coordinates (X, Y, Z) are generated to produce a 3D image. Rather, the “3D representation” is obtained from rotating the series of two dimensional pictures.

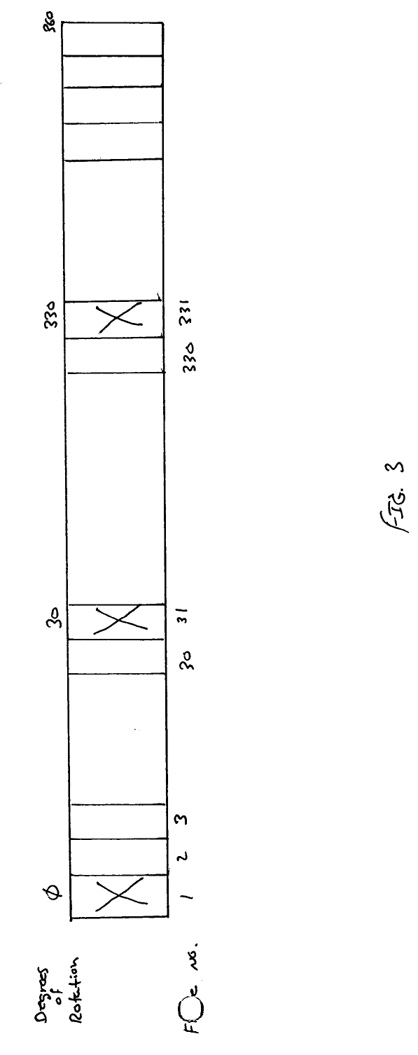

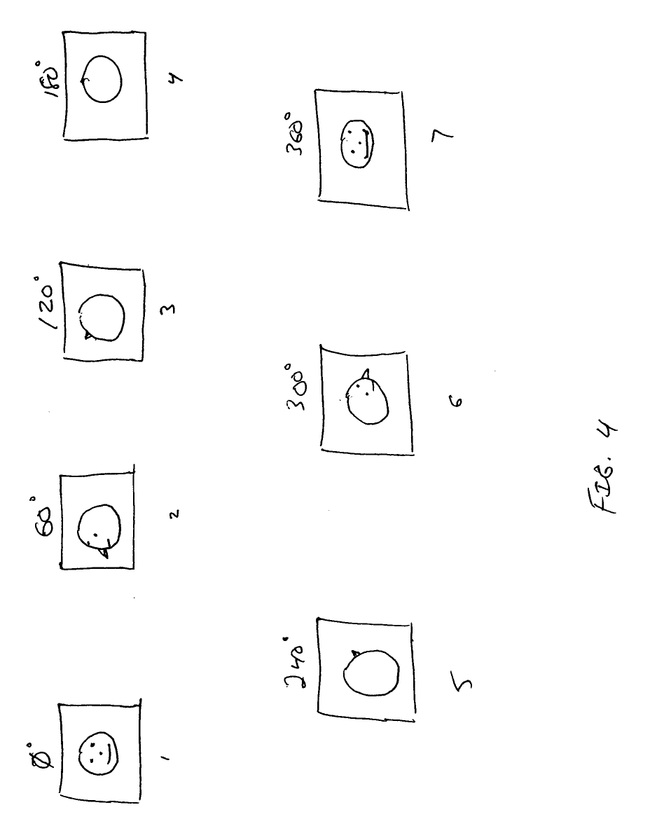

FIG. 2 shows a time line from 0 to 12 seconds (12 seconds being the period T in this example) showing how the corresponding number of 360 frames match up to the given time intervals. In this case, there is an angular displacement of 30° every second. Therefore, to achieve a desired resolution of 30° (one image taken of the object 20 every 30°), there are 12 images of the object 20 spaced 30° apart which make up the 3D representation, as illustrated by the marked frames in FIG. 3.

To determine the period T of the turntable 30 without using any mechanical or electrical controller, the present invention uses a system of pixel matching analysis whereby the video data stream itself is utilized to determine the rotational speed of the turntable 30. In operation, the video camera 40 is turned on while the turntable 30 rotates (in this embodiment at a constant speed about the axis 35). The camera 40 records for a given time period, perhaps, for 5 complete revolutions of the turntable 30. When the camera 40 has recorded the video data stream, the series of images which makes up the data stream is then analyzed by software through pixel matching to determine the speed of the turntable 30. This is accomplished by comparing the initial frame (i.e., frame #1) of the video data stream to each subsequent frame that is captured. When the pixel matching software determines that a subsequent frame is identical or closely identical to the initial frame, a match has occurred representing the return to the initial position of the object 20 and the turntable 30. Thus, the video data stream between the initial frame and a subsequent matched frame represents video data of one complete revolution of the turntable 30. Furthermore, the length (in time) of this video data segment between the initial and matched frames is also the period T of one complete revolution of the turntable 30. In this manner, the speed of rotation of the turntable 30 is determined by using only the video data stream itself and no other mechanism.

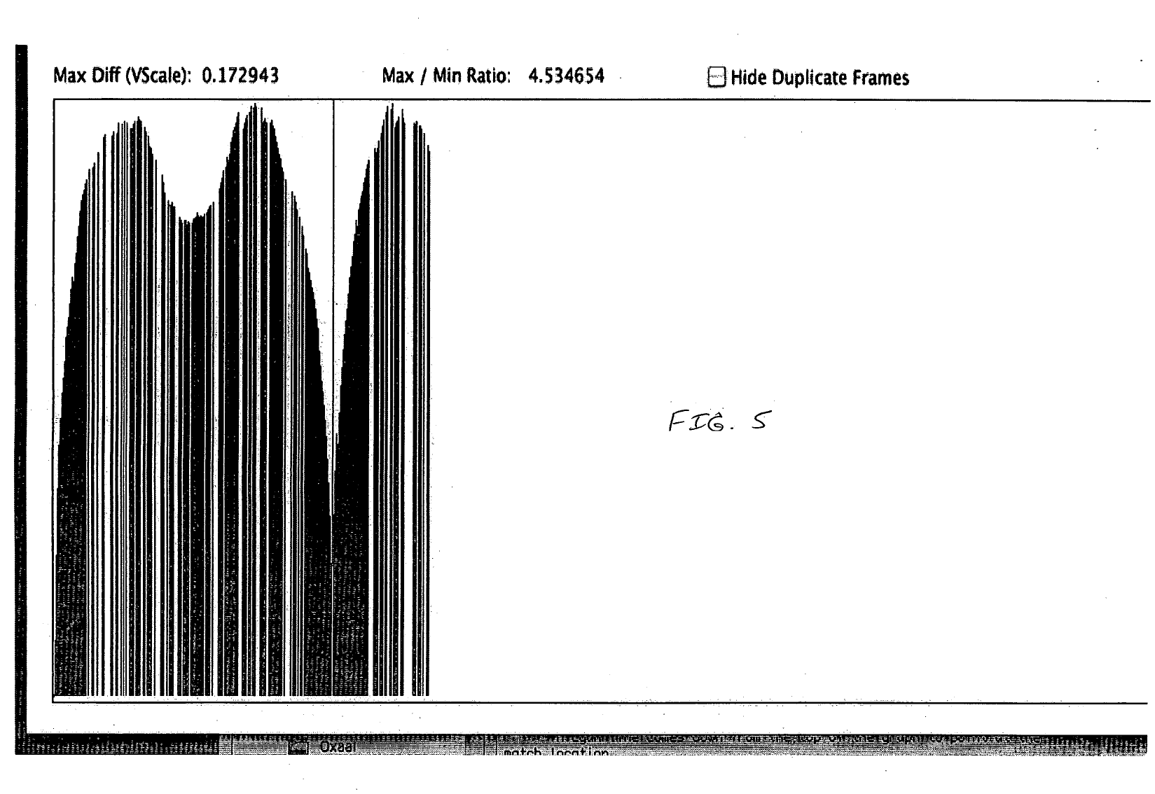

FIG. 4 shows an example of pixel matching analysis which is accomplished by the software. FIG. 4 shows a series of 7 images of the same object, each successive image rotated by approximately 60°. Images 1 and 7 are shown to be substantially identical, both images at 0° rotation from the initial point. The pixel matching software, having taken image 1 as its reference image, then examines each successive image (including all those images not shown between each image in FIG. 4) until it reaches a second image which substantially matches image 1, in this case image 7. Thus, when image 7 is identified by the pixel matching software, the system knows that one complete revolution has occurred. Furthermore, FIG. 4 illustrates what a resulting series of images might be like once the time period T for one complete revolution has been determined. For example, in FIG. 4, the desired resolution is 60°. Therefore, only six images (1-6) as shown in FIG. 4 will be utilized in the final 3D representation for display on a screen. Image 7 will not be used because image 1 depicts the same view of the object.

FIG. 5 is a graph showing an example of color coded video difference values generated by one type of pixel matching software for the captured object 20 used with the present invention. The video difference values are plotted frame by frame, starting at the left, and range from 0.0-1.0 (based on the percentage of pixels determined by the software to be different from the previous frame (the first two digits after the decimal essentially represent the percentage of pixels that were determined to be different). The graph is auto-scaled to the max difference value (as noted above the graph). The cyan colored line extending from the top of the graph indicates the match location as determined by the software, and thus indicates the completion of one revolution of the object 20. The graph to the right of the cyan line looks like the beginning of the graph since it corresponds to the next revolution of the same object 20.

In addition, the pixel matching software which produced the graph of FIG. 5 also checks for duplicate frames of the object capture. A video difference value shown in green corresponds to frames that are clearly different from the prior frame. A yellow color means that the frame was close enough to be a duplicate from to be double-checked by the software, but not found to be a true duplicate (lots of yellow means the pixel matching analysis is taking longer than necessary by virtue of the extra comparisons to check for duplicates). Red corresponds to true duplicate frames.

It should be noted that, no one particular type or method of pixel matching is necessary for the present invention to be realized. There are numerous pixel matching algorithms which can be used by a variety of software processes to accomplish the same task (recognizing a subsequent identical frame) with varying degrees of success depending on the type of image being captured. For example, the algorithms employed in certain types of pixel matching are better suited for certain types of objects, thereby yielding a more accurate pixel matching result. Therefore, while the present invention uses pixel matching, any suitable pixel matching scheme may be used with the present invention. Similarly, any suitable 3D playback imaging software method, such as Apple's QuickTime, may be used with the present invention.

Since the present invention does not utilize any automatic or mechanical control mechanism to control the speed of the rotating turntable 30, the described method has certain advantages in determining the period of rotation. Using this inventive method, the turntable can be less expensive because the speed does not have to be accurately controlled. As already noted, the speed does not have to be known prior to initiation of the rotation for picture capture. Furthermore using this technique, the speed could vary from object-to-object or turntable-to-turntable. For example, for one rotation the speed might be 3.9 RPM, while with another object for a different turntable, the speed might be 6.7 RPM. The same system could be used to determine the rotational time T in both systems without altering the method or equipment whatsoever. This lack of a need for prior knowledge allows for the use of a much less costly system and turntable while still providing accuracy and versatility. For example, in one embodiment, the turntable could be an extremely primitive one, turned on by a switch to rotate at any unknown speed.

In an alternative embodiment, the capturing system according to the present invention does not even rely on a constant rotational speed. Using similar pixel matching techniques as described above, it is possible to accommodate variations in the rotational speed of the turntable within a single rotation. For example, the turntable 30 may be a manual type, such as a lazy Susan, where there is no automatic control of motion of the turntable. In this type of system, the user must initiate rotation of the turntable by providing some rotational force to begin rotation about the axis 35. Because there is no constant rotational force being applied, the rotational speed of the turntable 30 will vary from rotation-to-rotation and even within a single rotation. However, the present invention of using the video data stream to determine the period T for one complete resolution accounts for these situations as well.

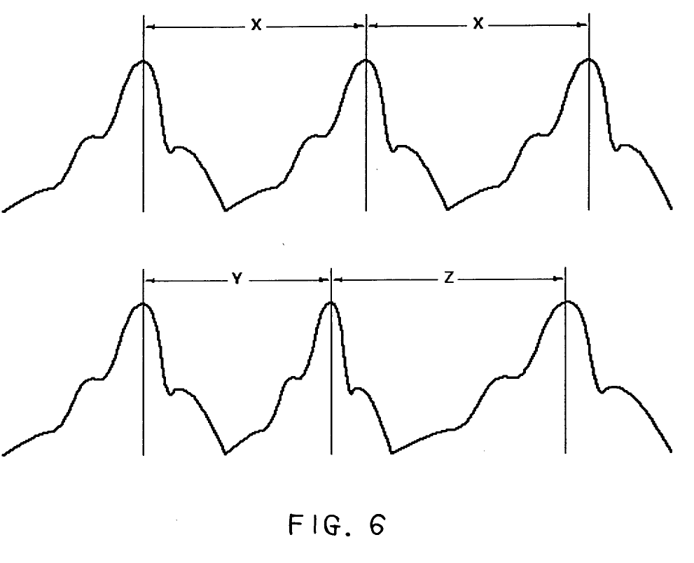

FIG. 6 shows a further example of video difference data for an object 20. In the upper graph the turntable 30 is rotating at a constant speed, such that the period T of each revolution (based on pixel matching) of the turntable 30 is denoted by the value X. However, in the lower graph, the turntable 30 has a different rotational speed for each revolution. Thus, the video difference data is compressed for a higher rotational speed having a period Y, and expanded for a lower rotational speed having a period Z. Thus, as seen from FIG. 6, the present inventive method determines the period T from the video difference data generated from the pixel matching software no matter how the video difference data is spaced.

The process of the present invention is now described in detail.

1. An object 20 is placed on the turntable 30. The user then initiates rotation of the turntable 30, through any means to provide rotation (e.g., manual, motorized).

2. The video camera 40 captures a stream of video frames of the object 20 while the object 20 is rotated by the turntable 30. The amount of time for initial capture is not important so long as the video camera 40 is assured of capturing just over one complete revolution of the turntable 30. If a full revolution occurs in, for example, 12 seconds, then a capture session might last for approximately 15 seconds.

3. Once the frames are captured by the camera 40 (or even while they are being captured) a pixel matching software process examines the captured frames for matches and generates video difference data. The first image in the sequence can be used as a reference. For example, assume that the first frame of the video data has a unity value of 1. Subsequent frames will have decreasingly less of a unity value, as they get further away from a match with the initial frame (for example, 0.99, 0.98, 0.97). These decreasing video difference data values reflect that a given captured frame of the object is less and less similar to the initial reference frame as the object rotates away from its original position. As the turntable 30 completes one revolution and begins to return to its initial position, the video difference data values begin to increase and re-approach the unity value of 1.

4. Once the referenced image is matched with its corresponding image, thereby indicating one complete revolution, the data segment between the initial reference frame and the matching frame is then processed to select the intermediate frames of the object 20 from the video data stream based upon the predetermined desired resolution and the known frame rate of the video camera 40. This can be determined based on either how many images of the object 20 the user wishes to include in the animated 3D representation or how often (in degrees) the user wants to capture an image of the object.

An additional embodiment of the described method may include a turntable 30 which requires repeated hand-based movement for rotation. That is, the turntable 30 might be moved by a user's hand from position-to-position to rotate the object 20 past the video camera 40 to capture the video data stream. Such a system will inherently include shifts in frequency of rotational speed, which the inventive method can accommodate.

In another embodiment of the present invention, the turntable 30 turns more than one revolution (i.e., 5 revolutions) during a capture session. This yields five frames of each particular orientation or angle of the object 20. These five frames of the same image are then combined (through interpolation) into each other to yield a much higher quality image, video or animation. The inventive method is desirable for this process because the rotational speed of the turntable 30 has no bearing on image capture. A conventional system is susceptible to inconsistencies caused by mechanical and/or electrical variations affecting rotational speed which would be magnified over multiple rotations, thereby making it more difficult to perform an interpolation process.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

What is claimed is:

1. A method of generating a three-dimensional image of an object, the method comprising:
(a) placing a video camera at a predetermined distance from the object, such that the video camera has an unobstructed view of the object;
(b) causing the object to rotate about a central axis;
(c) capturing a video stream of at least one revolution of the rotating object with the video camera;
(d) determining a period of the at least one revolution of the object;
(e) selecting a predetermined number of frames of the captured video stream; and
(f) creating a three-dimensional image of the object using the selected frames.

2. The method of claim 1 wherein the object is caused to rotate by placing the object on a rotating turntable.

3. The method of claim 2 wherein the turntable is freely rotatable about the central axis.

4. The method of claim 2 further comprising:
(g) driving the turntable by a motor controller.

5. The method of claim 1 further comprising:
(g) using pixel matching analysis to determine the period of the at least one revolution.

6. The method of claim 1 wherein the predetermined number of frames are selected at predetermined intervals of the captured video stream.
